(19) United States
(12) Patent Application Publication
(10) Pub. No.: US 2026/0250031 A1
(43) Pub. Date: Aug. 27, 2026

(54) LABELLING APPARATUS AND METHOD

(71) Applicant: ACMI LABELLING S.R.L., SORBOLO (PR) (IT)

(72) Inventors: PAOLO LANFREDI SOFIA, IMOLA (IT); ALESSANDRO GAZZINI, IMOLA (IT); MAURIZIO PEDERCINI, IMOLA (IT)

(21) Appl. No.: 19/489,706

(22) PCT Filed: Jun. 4, 2024
(86) PCT No.: PCT/IB2024/055429

§ 371 Date: Dec. 3, 2025

(30) Foreign Application Priority Data
Jun. 6, 2023 (IT) 102023000011433

(51) Int. Cl. B65C 9/18; B65C 9/00; B65C 9/22; B65C 9/30; B65C 9/42

(52) U.S. Cl. CPC B65C 9/1819; B65C 9/2256; B65C 9/30; B65C 9/42; B65C 2009/0075; B65C 2009/1838

(57) ABSTRACT

A labelling apparatus includes: a feed roller (11), configured to feed a web, the web being made from a label material; a transfer carousel, configured to receive the web from the feed roller in a loading zone and including a plurality of recesses, angularly distributed along a periphery of the transfer carousel, the transfer carousel rotating about a first axis and the first axis being oriented longitudinally; a knife, operating on the portion of web facing the recess, to separate pieces of web constituting labels and configured to vibrate longitudinally.

### TECHNICAL FIELD

This invention relates to a labelling apparatus and method. In particular, this invention regards the mode of cutting a labelling web to obtain labels which are then applied to containers.

### BACKGROUND ART

With regard to the cutting of the web into labels, different approaches are known in the prior art.

According to a first approach, cutting is accomplished by pressure through the interaction between a knife and an anvil with the label interposed between them. This solution is described in patent documents EP2067701B1, EP2221154B1, EP2279954B1, DE102013215999A1 and EP3919397A1; this solution, however, has the disadvantage of rapid knife wear.

According to a second approach, the apparatus comprises slots or recesses and cutting is accomplished through the interaction between the knives and the slots; in an example, the knives are located in the recesses of a carousel which transports the web and cutting occurs by sucking the web into the slot. Examples of this solution can be found in patent documents WO2021239626A1, WO2021198072A1 and WO2022069415A1. In an alternative example, the knife is located on a cutting roller and is cyclically inserted into the recesses of the transporting roller so as to cut the web. Patent document EP3925743A1 describes an example of this approach. The solutions with recesses have the advantage of being more reliable than the solution in which the knives interact with anvils; however, the method of cutting with the recesses has the disadvantage of making cuts that are not very precise and for that reason, the label might not be cut correctly, leading to cutting defects or labelling flaws.

### DISCLOSURE OF THE INVENTION

This disclosure has for an aim to provide a labelling apparatus and method to overcome the above mentioned drawbacks of the prior art.

In particular, the aim of this disclosure is to provide a labelling apparatus and method capable of cutting the label precisely and in a manner that is at once simple and reliable.

This aim is fully achieved by the apparatus and method of this disclosure as characterized in one or more of the appended claims.

The web may be made from a polymeric material, but it could also be made from other materials.

In particular, the labels are obtained from the web by cutting the web in such a way that each cut separates a piece of web from the web itself, where each piece defines a label. Preferably, the labels are rectangular in shape (in particular, the cut is perpendicular to the web); embodiments in which the labels have a different shape (for example, rhomboidal) are not excluded, however.

In a possible embodiment, the labelling apparatus, and/or one of the components thereof, may be made according to what is described in patent document 102022000024309, which is in the name of the present Applicant and the description of which is incorporated herein by reference.

The apparatus comprises a feed roller. The feed roller is configured to feed a web, the web being made from a label material. In particular, the web is at least partly wound around the feed roller. In an example, the feed roller rotates about a vertical axis, the vertical axis being preferably perpendicular to a plane in which the feed path of the web extends. The feed roller has the function of applying an entraining action on the web.

The apparatus comprises a transfer carousel. The transfer carousel may have the function of defining a movement path along which the web moves. On the web movement path of the transfer carousel, the web is kept adherent to the transfer carousel (for example, on a lateral surface of the transfer carousel). In particular, the transfer carousel rotates about a first axis, that is, a first vertical axis. The first axis is oriented longitudinally. Preferably, the first axis is oriented perpendicularly to a plane in which the feed path of the web extends. Thus, in its rotational motion about the first axis, the transfer carousel defines the web movement path. The transfer carousel is configured to receive the web from the feed roller in a loading zone. In particular, the loading zone is part of the movement path. In other words, along the movement path, the transfer carousel interacts with the feed roller to receive the web.

The transfer carousel includes a plurality of recesses. The plurality of recesses are angularly distributed along the periphery of the transfer carousel.

The apparatus comprises a knife. The knife operates on the portion of web facing the recess, to separate pieces of web constituting labels. Thus, the web interacts with the knife in a cutting zone along the movement path.

In an example embodiment, the movement path includes a stretch that is positioned downstream of the recess (or of the cutting zone); thus, the movement path is a path for moving the web as far as the recess, where the knife acts on the portion of web facing that recess (that is, as far as the cutting zone), after which, downstream of the recess (that is, downstream of the cutting zone), the movement path is a path for moving the pieces of web, that is to say, the labels.

The unloading zone is angularly spaced from the web loading zone.

In particular, the knife is configured to vibrate longitudinally, that is, perpendicularly to the web, that is, perpendicularly to a feed direction of the web along the movement path. Vibrating the knife allows the label to be cut in a precise and reliable manner.

In particular, the knife may include (at least) one serrated blade. The serrated blade may be disposed longitudinally (in this case, the cut label is rectangular in shape) or it may be disposed otherwise, for example, transversely to the longitudinal direction, so as obtain other label shapes (for example, rhomboidal).

Preferably, the direction along which the knife is disposed (that is, the direction along which a blade of the knife is disposed) coincides with the vibration direction of the knife.

The apparatus may comprise an actuator, connected to the knife and configured to vibrate it. The actuator may be a pneumatic actuator, or an electromagnetic actuator, or an ultrasound (that is, piezoelectric) actuator. The vibration frequency of the knife may be (approximately) between 10 Hz and 40 kHz, for example, that is, the knife may be configured to vibrate at a frequency of (approximately) between 10 Hz and 40 kHz. Preferably, the vibration frequency of the knife may be at least 500 Hz, more preferably at least 1 kHz. It is preferable that the vibration frequency of the knife is less than 60 kHz, so to be able to provide an appreciable stroke (for example in the preferred ranges for the stroke recommended in this description) without having to resort to too high power.

In particular, the vibration frequency of the knife may be (approximately) between 10 Hz and 40 kHz, preferably in the case where the actuator is an ultrasound actuator. In particular, the vibration frequency of the knife may be (approximately) between 10 Hz and 10 kHz, more preferably (approximately) between 10 Hz and 1 kHz in the case where the actuator is a pneumatic actuator or an electromagnetic actuator.

In the longitudinal translation of its vibrational motion, the knife may be configured to perform a stroke of (approximately) between 0.02 and 0.5 mm. In particular, the stroke may be (approximately) between 0.02 and 0.1 mm, more particularly (approximately) 0.04 mm, preferably in the case where the actuator is an ultrasound actuator. In particular, the stroke may be (approximately) between 0.1 and 0.5 mm, preferably in the case where the actuator is a pneumatic actuator or an electromagnetic actuator.

Generally speaking, in its longitudinal vibrational motion, the knife may be configured to perform a stroke whose length is inversely proportional to the vibration frequency of the knife.

In an example embodiment, the apparatus comprises a cutting roller. The cutting roller rotates about a second axis, parallel to the first axis (of the transfer carousel). Preferably, in this case, the knife is located on the cutting roller. The cutting roller may be configured to act in conjunction with the recesses of the transfer carousel (in a cutting zone). The knife rotates as one with the cutting roller. In particular, the knife is configured to be inserted cyclically into the recesses of the transfer carousel to cut the portion of web facing the recess into labels. Thus, the transfer carousel is configured to interact with the cutting roller to cut the web into labels.

In another example, the knife is located in the recesses of the transfer carousel. The apparatus may therefore comprise a knife for each of the recesses of the transfer carousel. It is noted, in this case, that the cutting roller might not be present. The recesses of the transfer carousel may each be configured to apply a sucking action on the web in order to divide the web into labels. In particular, the sucking action applied by the recess is synchronized with the movement of the web on the transfer carousel so as to divide the web into labels by interaction of the web with the knife located in the recess. The suction applied on the web therefore has the function of pulling the web against the knife so as to cut it. In particular, since the knife is configured to vibrate, cutting the label is accomplished by combining the sucking action applied on the label with the vibration of the knife. When the knife is located in the recesses of the transfer carousel, the web may be pre-glued.

A vibration cycle is defined as a cycle in which the knife makes a longitudinal movement from a first end and a second end and a further longitudinal movement from a second end to a first end (i.e. a cycle in which the knife moves longitudinally and returns at the starting point). Preferably, at an interference time where the knife is within the recess for cutting the tape, the knife is configured to perform at least half a cycle of vibration, or, in other words, the knife is configured to move longitudinally from a first extreme to a second extreme. More preferably, the knife is configured to perform one cycle of vibration, even more preferably at least two or three cycles of vibration.

Below, an example of what is expressed above is provided.

An interference distance of the knife inside the recess of approximately 2 mm is considered, where “knife interference distance” indicates the length of the knife that is inserted inside the recess. A recess opening angle of approximately 4.5° is considered, where “recess opening angle” indicates the angle calculated at the perimeter edge of the transfer carousel with respect to the center of the transfer carousel. Using a pneumatic vibrator capable of generating a knife vibration frequency of 150.7 Hz at 6 bar and considering the inertias involved, the pneumatic vibrator determines a longitudinal displacement of the knife of approximately 0.25 mm and a cycle time of approximately 6.6 ms. In the case in which the production speed wants to be 60000 bph (bottles labeled per hour) and you have a transfer roller of 6 div, the interference time of the knife inside the recess is 4.5 ms, which would correspond to a frequency of 222.2 Hz. The vibration of the knife at a frequency of 150.7 Hz is 67.8% of the frequency needed to complete one cycle in the interference time. However, since one vibration cycle corresponds to two complete movements, it is possible, at 60000 bph, to reach a movement of 0.25 mm in the label cutting phase.

It is observed that the interaction time of the knife with the label depends on the diameter of the shaft on which the knife is fixed, the diameter of the transfer carousel and the interference value of the knife in the recess for cutting the label. Assuming to have at least one full excursion of the knife during the interaction time of the knife with the belt, based on the hypothesized speeds of 60000 bph, the ratios of the diameters of the carousels and the contact angle of the knife with the belt, a interaction time of 4.5 ms. With this interaction time and the hypothesized geometry, it is necessary to have a frequency around 100 Hz to have a complete vertical stroke of the knife.

In one example, the apparatus (the cutting roller) includes a shaft, extending along the second axis and configured to rotate around the second axis of rotation. The shaft is configured to transmit a rotary motion to the knife. The cutting roller includes a rotation actuator, configured to rotate the shaft around the second axis. The cutting roller includes a support structure and the shaft is fixed to the support structure. The cutter reel includes a pair of flanges or bushings, configured to support the shaft to the cutter reel structure.

In one example, the shaft includes an internal rod and an external sleeve surrounding the internal rod. The rotation actuator can be connected to the external sleeve or, more preferably, to the internal rod of the shaft, so as to place the external sleeve or the internal rod in rotation around the second axis. In particular, the external sleeve is fixed to the internal rod in such a way that the external sleeve is dragged into rotation by the internal rod. For this purpose, the external sleeve and the internal rod can be fixed to each other by a mechanical constraint system (for example a key), configured to constrain the rotary movement.

The internal rod is configured to (i.e. is free to) move longitudinally. In particular, the internal rod is configured to vibrate longitudinally. The knife is fixed to the internal rod. Therefore, the internal rod is configured to vibrate the knife along the longitudinal axis. In this case, the mechanical constraint system is configured to constrain the rotary movement of the internal rod to the rotary movement of the external sleeve (and vice versa) and to allow the longitudinal vibration movement of the external sleeve with respect to the internal rod. Preferably, the longitudinal axis and the second axis coincide or are parallel to each other.

The shaft may include one or more support elements, for example cup springs, to support the longitudinal vibration movement of the internal rod. The cutting roller may include a vibration actuator configured to vibrate the internal rod. Such a vibration actuator can be a pneumatic actuator, an electric motor (for example with an eccentric element), a piezoelectric actuator or other types of actuators.

It is envisaged that the vibration actuator is controlled (for example intermittently or in a variable way) by the control unit, in a synchronized manner with respect to the feeding of the web and/or the rotation of the transfer carousel.

Therefore, the internal rod constitutes a vibrating support to which the blade (knife) is fixed. This vibrating support is slidably coupled to a stationary support, which in the example described above is constituted by the external sleeve of the shaft; preferably, the vibrating support is slidably coupled to the stationary support via the cup springs. The vibrating support is set to vibrate relative to the stationary support via the vibration actuator. This approach can also be used advantageously in the embodiment in which the vibrating blade is positioned inside each recess of the transfer carousel; in this case, each recess of the transfer carousel is provided with a guide integral with the transfer carousel, such a guide defining the stationary support, the vibrating support being coupled to this guide; wherein each recess of the transfer carousel is further provided with its own actuator of vibration. It is envisaged that the vibration actuators are controlled (selectively and in succession) by the control unit, in a synchronized manner with respect to the feeding of the web.

In an example embodiment, the transfer carousel includes a plurality of suction protrusion arrangements (or pads). Each suction protrusion arrangement comprises a corresponding recess of the plurality of recesses. The suction protrusion arrangements of the plurality of suction protrusion arrangements are angularly distributed along a periphery of the transfer carousel. In this case, the transfer carousel is configured to keep the web adherent to one or more of the suction protrusion arrangements.

In particular, each recess divides the respective suction protrusion into two portions, or expansions, so that each suction protrusion includes a leading expansion and a trailing expansion, where the recess is interposed between the leading expansion and the trailing expansion. In the rotation direction of the transfer carousel, the leading expansion precedes the trailing expansion. Preferably, the leading expansion and the trailing expansion project radially from the transfer carousel, away from the first axis of the transfer carousel.

The transfer carousel is configured to keep the web adherent to one or more of the suction protrusion arrangements. The transfer carousel may also be configured to keep the label separated from the web adherent to one or more of the suction protrusion arrangements.

The rotation of the cutting roller and the rotation of the transfer carousel are synchronized so that the knife of the cutting roller is inserted cyclically into the recesses of the suction protrusion arrangements in order to cut the web. The interaction between the knife of the cutting roller and the recesses of the suction protrusion arrangements of the transfer carousel takes place during a step of cutting. Thus, the web is cut during the step of cutting to separate a piece of it.

In an example, the apparatus comprises a gluing roller. The gluing roller is configured to spread glue on the surfaces of the web or on the surfaces of the labels. In particular, each label defines a leading end zone and a trailing end zone, relative to a feed direction along the movement path. The gluing roller is configured to spread glue on the surfaces of the web intended to define the leading end zone and the trailing end zone (of the same label, or the leading end zone of a first label and the trailing end zone of a second label following next after the first) or to spread glue on the leading end zone and the trailing end one of a label or on the trailing end zone of a first label and a leading end zone of a second label following next after the first. Thus, the gluing roller may be configured to interact with the transfer carousel downstream or upstream of the cutting roller.

In an example, the apparatus may comprise an additional transfer carousel, distinct from the transfer carousel. The additional transfer carousel may be located (preferably) downstream of the transfer carousel relative to a feed path of the web. The additional transfer carousel may be configured to interact with the gluing roller to apply glue. The additional transfer carousel may comprise a plurality of suction protrusion arrangements, where the plurality of suction protrusion arrangements may be made according to one or more of the aspects described herein. The gluing roller may therefore be configured to interact with the additional transfer carousel (that is, the gluing roller may be synchronized with the additional transfer carousel) so as to apply glue on the web or on the labels at the suction protrusion arrangements. The additional transfer carousel may be configured to transfer the labels onto containers in an unloading zone.

The additional transfer carousel may therefore define a carousel that is dedicated to interacting with the gluing roller.

Thus, there are at least two possible approaches. According to a first approach, gluing and cutting are carried out on labels (or web) transported by the same transfer carousel (that is, the transfer carousel). In a second approach, the labels (or the web) are transported by two distinct carousels, that is, the transfer carousel and the additional transfer carousel; in an example, cutting and gluing are carried out on labels transported by the transfer carousel and on labels transported by the additional transfer carousel. Thus, when there are two distinct transfer carousels, that is, the transfer carousel and the additional transfer carousel, the web is cut on the carousel upstream relative to the web path, whilst the carousel downstream relative to the web path is used for applying the glue and transferring the labels onto the containers in the unloading zone.

Whatever the case, if there is no gluing roller, the web may be pre-glued. In an example, the gluing roller rotates about a third axis and the third axis is parallel to the first axis (that is, it is oriented longitudinally).

In an example embodiment, the transfer carousel might act in conjunction with a labelling machine (or central carousel) to transfer the labels on containers (in an unloading zone). In another example, the additional transfer carousel is configured to receive the cut labels from the transfer carousel and to act in conjunction with a labelling machine (or central carousel) to transfer the labels on containers (in an unloading zone).

In an example, the rotation of the cutting roller and the rotation of the transfer carousel are synchronized so that the cutting roller is inserted cyclically into the recesses of the suction protrusion arrangements in order to cut the web. The rotation of the gluing roller may also be synchronized with the rotation of the transfer carousel so that the gluing roller cooperates with the suction protrusion arrangements of the transfer carousel to apply glue.

The apparatus includes a control unit. Synchronizing the different parts may be accomplished (exclusively) by mechanical systems. Synchronizing, however, is preferably accomplished through the control unit, also because the cutting roller, the gluing roller and the transfer carousel each include their own drive motor unit, configured to set them in rotation about the respective axes of rotation.

With regard to synchronization, readers are referred to patent document 102022000024309. Generally speaking, the transfer carousel, the gluing roller and the cutting roller may be made according to one or more of the features described in patent document 102022000024309.

The control unit might also be programmed to set a knife vibration frequency. For example, the vibration frequency of the knife may be set on the basis of a rotation speed of the transfer carousel or a rotation speed of the cutting roller, or a feed speed at which the web is fed to the transfer carousel (that is, on the basis of the speed of the feed roller).

In an example, the control unit might be programmed to synchronize the rotation of the transfer carousel (or to vary the feed speed of the web or to synchronize the rotation of the feed roller) and the vibration of the knife. Synchronization may occur in such a way that the knife starts vibrating upstream of the recess and stops vibrating downstream of the recess along a movement path of the transfer carousel. Alternatively, more preferably, the control unit is programmed to make the knife continue to vibrate, that is, to keep knife vibration constant during interaction between one recess and the next.

This disclosure also provides a labelling method.

The method comprises a step of feeding a web (the web being made from a label material). Preferably, the step of feeding the web is carried out by a feed roller.

The method comprises a step of providing a transfer carousel. Preferably, the transfer carousel rotates about a first axis, where the first axis is oriented longitudinally. As it rotates, the transfer carousel defines a movement path. In particular, the transfer carousel includes a plurality of recesses. The plurality of recesses are angularly distributed along the periphery of the transfer carousel.

The method comprises a step of receiving the web from the feed roller in a loading zone of the transfer carousel.

The method comprises a step of cutting a portion of web facing the recess with a knife in order to divide the web into pieces constituting labels.

In particular, the method comprises a step of vibrating the knife longitudinally.

The vibration frequency of the knife may be (approximately) between 10 Hz and 40 kHz, that is, the knife may vibrate at a frequency of (approximately) between 10 Hz and 40 kHz.

In particular, the vibration frequency of the knife may be (approximately) between 10 Hz and 40 kHz, preferably in the case where the actuator is an ultrasound actuator. In particular, the vibration frequency of the knife may be (approximately) between 10 Hz and 10 kHz, more preferably (approximately) between 10 Hz and 1 kHz in the case where the actuator is a pneumatic actuator or an electromagnetic actuator.

In the longitudinal translation of its vibrational motion, the knife may perform a stroke of (approximately) between 0.02 and 0.5 mm. In particular, the stroke may be (approximately) between 0.02 and 0.1 mm, more particularly (approximately) 0.04 mm, preferably in the case where the actuator is an ultrasound actuator. In particular, the stroke may be (approximately) between 0.1 and 0.5 mm, preferably in the case where the actuator is a pneumatic actuator or an electromagnetic actuator.

Generally speaking, in its longitudinal vibrational motion, the knife may perform a stroke whose length is inversely proportional to the vibration frequency of the knife.

In particular, the knife may comprise (at least) one serrated blade.

In an example, the transfer carousel includes a plurality of suction protrusion arrangements, angularly distributed along a periphery of the transfer carousel and each comprising a corresponding recess of the plurality of recesses. When the suction protrusions are provided, the method may include a step of keeping the web adherent to one or more suction protrusion arrangements by means of the transfer carousel.

The method may comprise a step of providing a cutting roller. The cutting roller rotates about a second axis, parallel to the first axis. Preferably, the knife is located on the cutting roller.

In an example, the method comprises a step of the cutting roller cooperating with the recesses of the transfer carousel in a cutting zone, in order to cut the web.

For example, the transfer carousel and the cutting roller may be synchronized so that the cutting roller is inserted cyclically into the recesses of the suction protrusion arrangements in order to cut the web.

In another example, the knife is located in the recesses of the transfer carousel. In this case, the method may comprise a step of the transfer carousel sucking the web into the recess so as to divide the web into labels. In particular, the movement of the web on the transfer carousel may be synchronized with the step of sucking the web.

In an example, the method may comprise a step of applying glue on surfaces of the web by means of a gluing roller. In particular, to apply glue, the gluing roller may interact with the transfer carousel with an additional transfer carousel.

The rotations of the gluing roller and of the transfer carousel may be synchronized so that the gluing roller applies glue on the surfaces of the web. Preferably, the gluing roller applies glue on the surfaces of the web positioned at the suction protrusion arrangements of the transfer carousel. In an example, the method comprises a step of the glue roller cooperating with an additional transfer carousel, distinct from the transfer carousel, in order to apply glue. The method may comprise a step of the additional transfer carousel cooperating with a labelling machine to transfer the labels onto containers (in an unloading zone).

The method may comprise a step of starting the vibration of the knife via an actuator.

There may be a step of setting a knife vibration frequency via a control unit. The vibration frequency may be set on the basis of a rotation speed of the transfer carousel or a rotation speed of the cutting roller, or a feed speed at which the web is fed to the transfer carousel (that is, on the basis of the speed of the feed roller).

There may be a step, performed via a control unit, of synchronizing the rotation of the transfer carousel (or the web feed speed or the rotation of the feed roller) with the vibration of the knife. Synchronization may be performed in such a way that the knife starts vibrating upstream of the recess and stops vibrating downstream of the recess along a movement path of the transfer carousel. Alternatively, more preferably, the control unit makes the knife continue to vibrate, that is, keeps knife vibration constant during interaction between one recess and the next.

### BRIEF DESCRIPTION OF DRAWINGS

These and other features will become more apparent from the following description of a preferred embodiment, illustrated by way of non-limiting example in the accompanying drawings, in which:

FIGS. 1A, 2A and 3A illustrate an apparatus 1 according to one or more aspects of this disclosure;

FIGS. 1B, 2B and 3B illustrate a cutting roller 13 according to one or more aspects of this disclosure;

FIG. 4 illustrates an apparatus 1 according to one or more aspects of this disclosure;

FIGS. 5A, 5B, 6A-6D schematically illustrate an apparatus 1 according to one or more aspects of this disclosure;

FIGS. 7A-7C illustrate a cutting roller 13 according to one or more aspects of this disclosure.

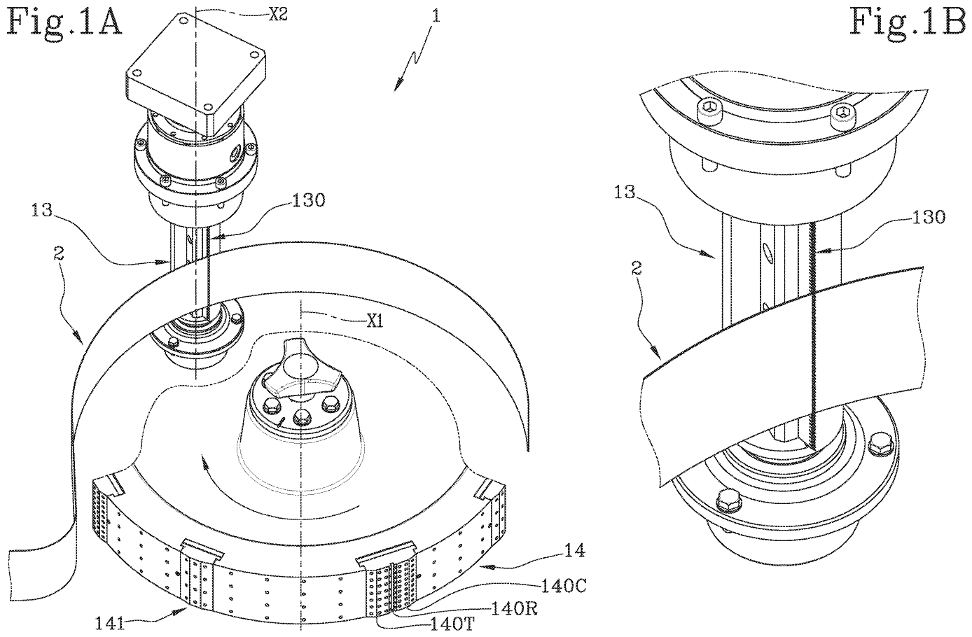

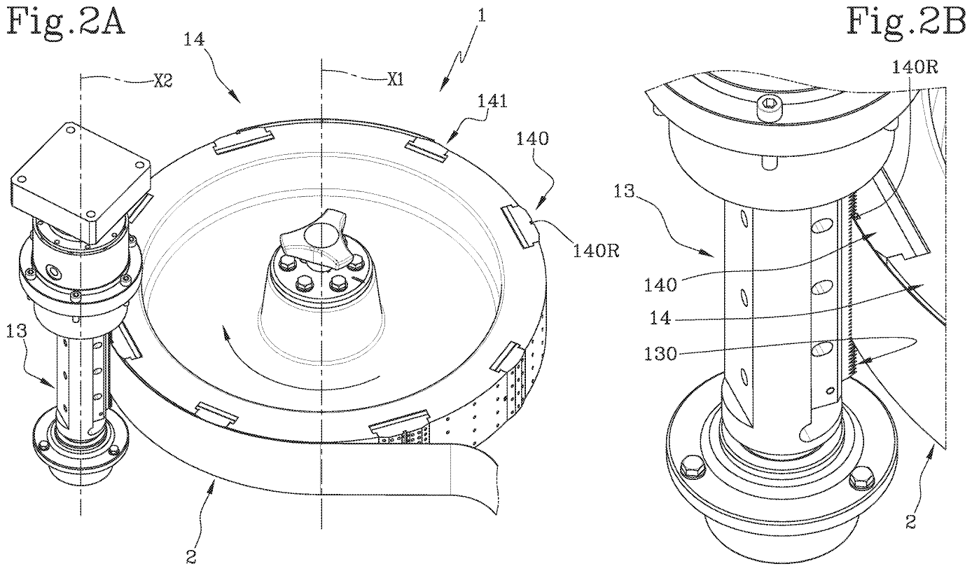

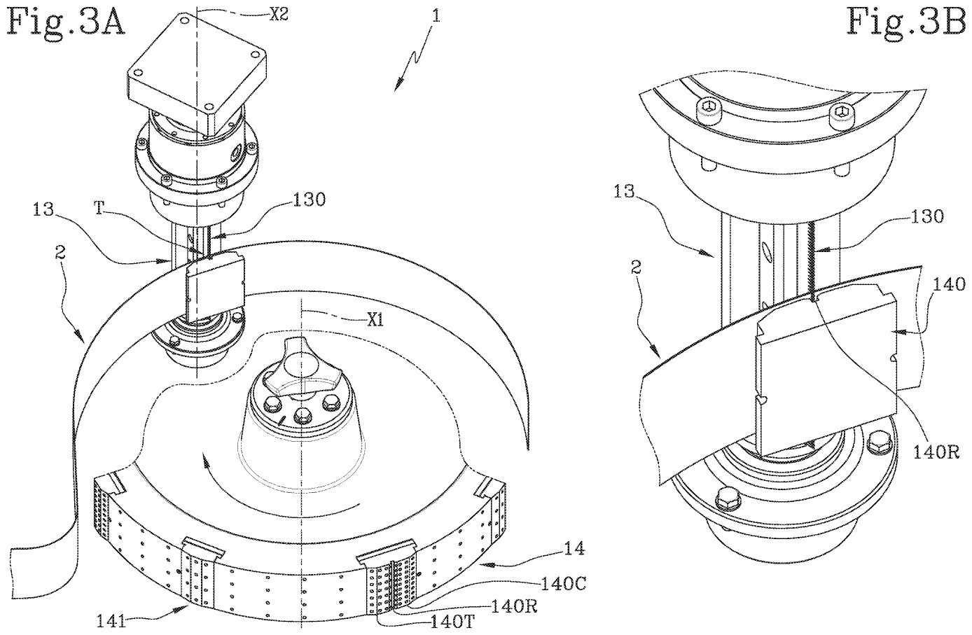

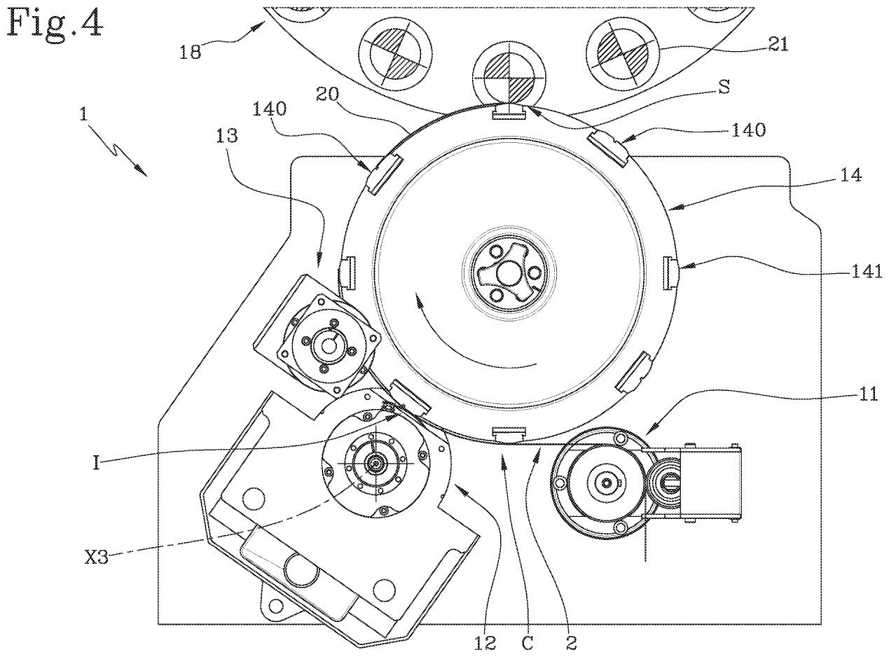

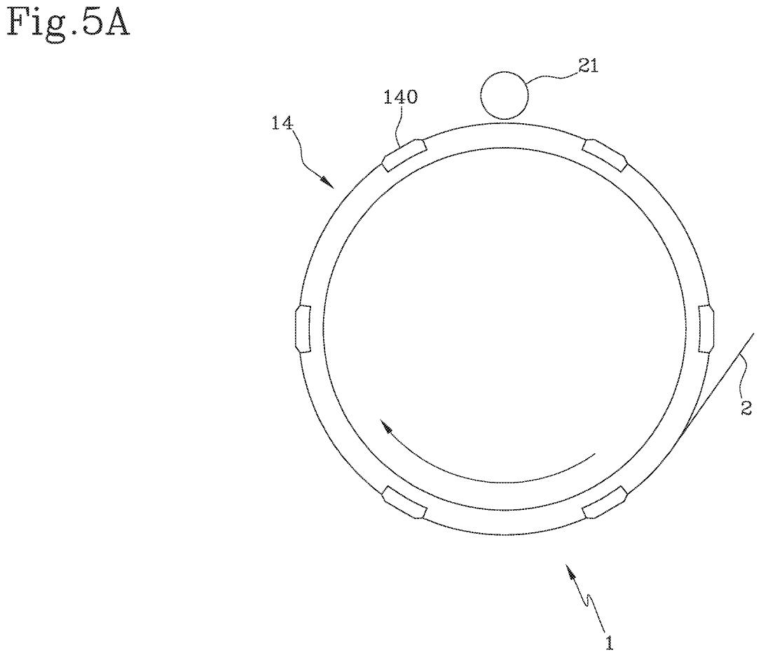

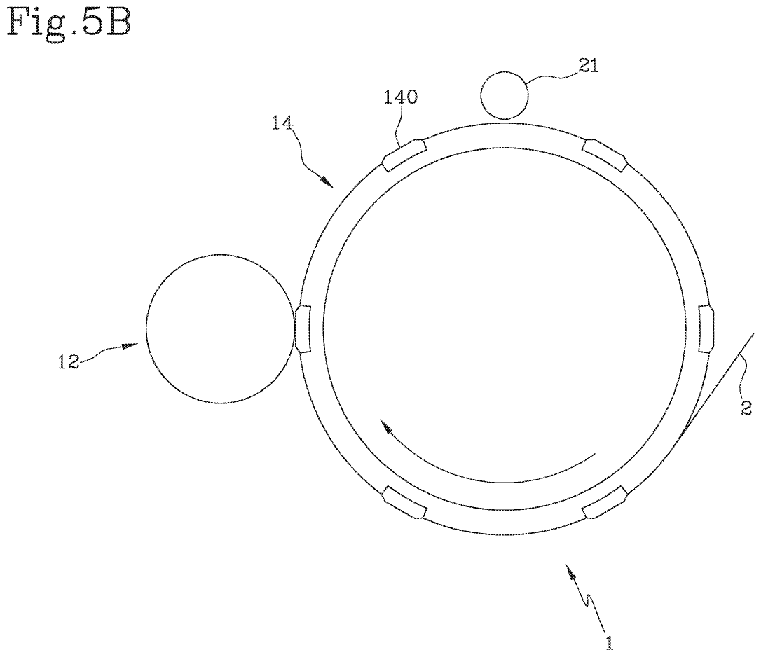

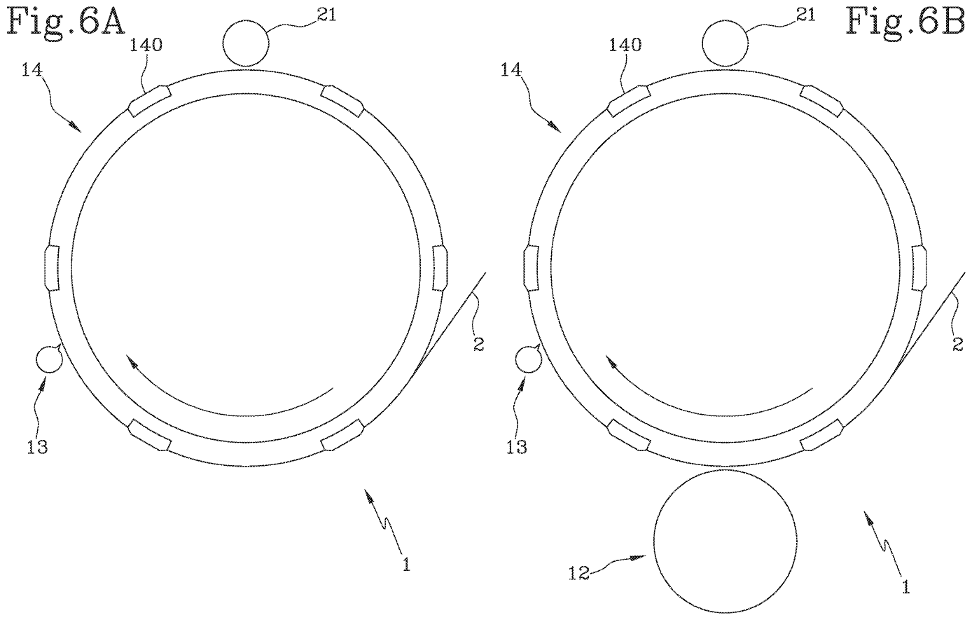

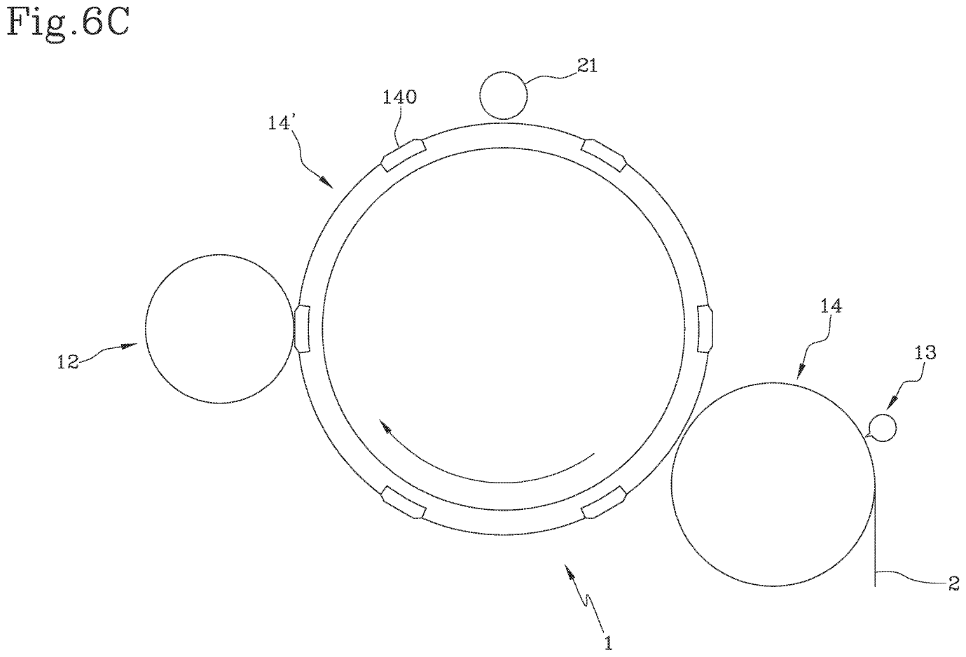

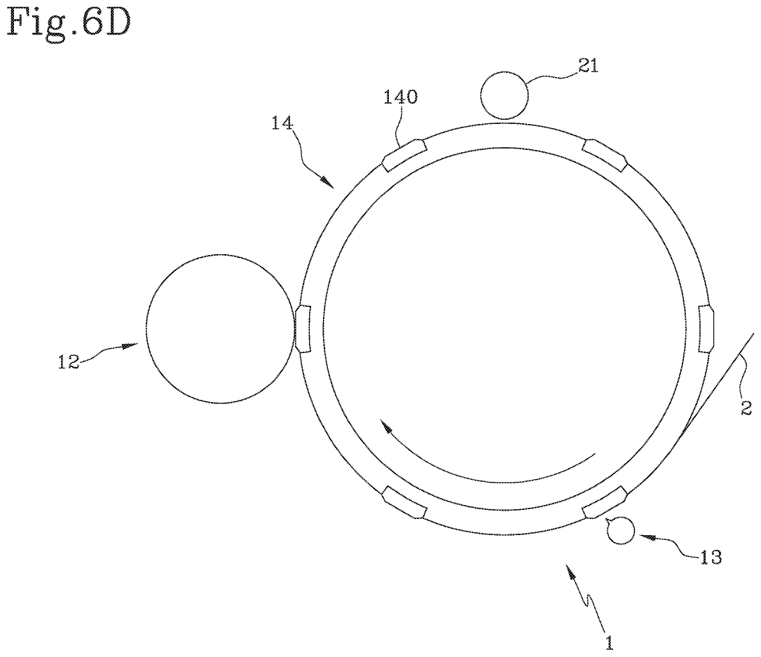

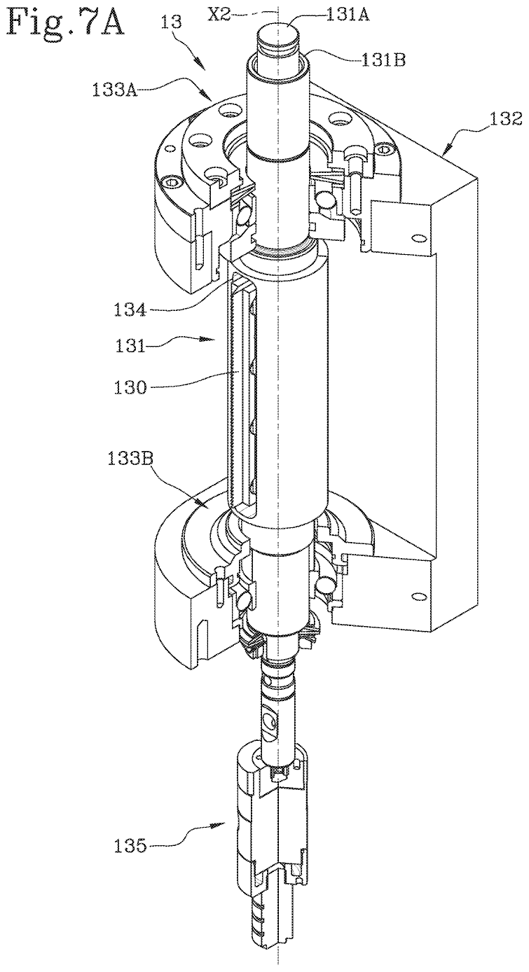

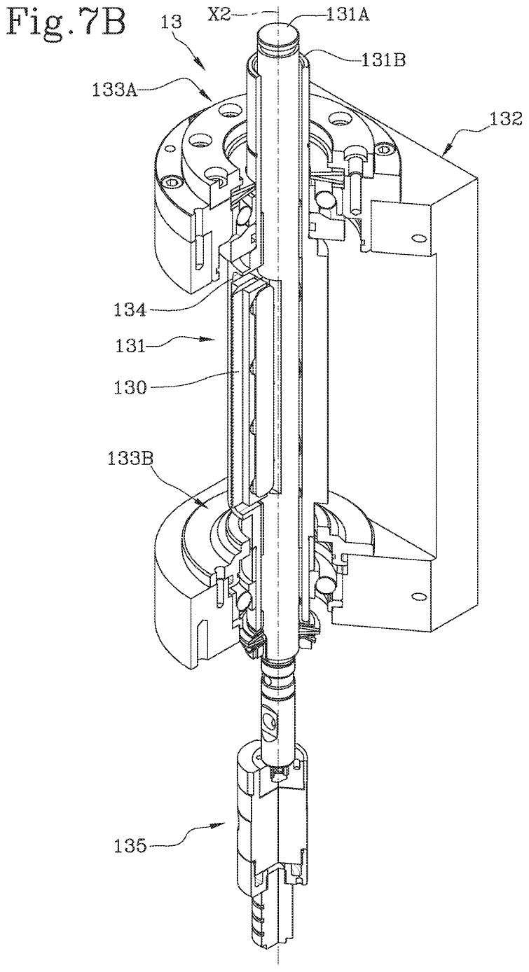

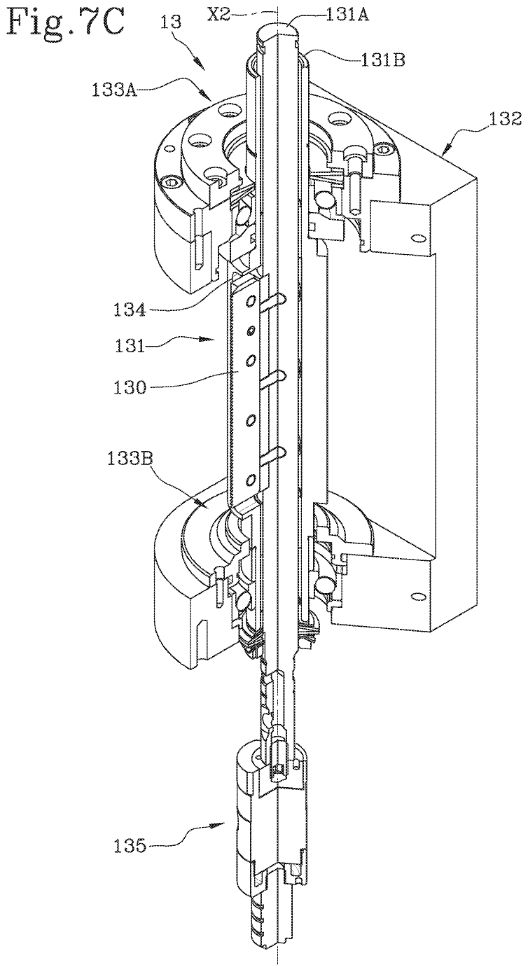

### DETAILED DESCRIPTION OF PREFERRED EMBODIMENTS OF THE INVENTION

The numeral 1 in the drawings denotes a labelling apparatus.

The apparatus 1 comprises a feed roller 11 and a transfer carousel 14. The feed roller 11 and the transfer carousel 14 each rotate about a respective axis of rotation; in particular, the transfer carousel 14 rotates about a first, longitudinal axis X1.

A web 2 of label material is wound around the feed roller 11. The feed roller 11 feeds the web 2 to the transfer carousel 14 in a loading zone C.

The transfer carousel 14 is configured to receive the web 2 from the feed roller 11 in the loading zone C and to transport the web 2 along a movement path. On the movement path, the web 2 is kept adherent to the transfer carousel 14.

The transfer carousel 14 comprises a plurality of recesses 140R, angularly distributed around the periphery of the transfer carousel 14.

The apparatus 1 comprises a knife 130, operating on the portion of web 2 facing the recess 140R, so as to separate pieces of web 2 constituting labels, in a cutting zone T. The cutting zone T is angularly spaced from the loading zone C of the web 2.

The knife 130 vibrates longitudinally, that is, perpendicularly to the web 2, that is, perpendicularly to a feed direction of the web 2 along the movement path.

In an example, the transfer carousel 14 comprises a knife 130 for each of the recesses 140R. In particular, the recess 140R is provided with suction ducts connected to a compressor or vacuum source to generate a sucking action; that way, the web 2 is pulled against the knife 130 which cuts it into labels. In particular, the sucking action is synchronized with the movement of the web 2 on the transfer carousel 14 (that is, with the rotation of the feed roller 11). At the same time, the knife 130 vibrates longitudinally to act in conjunction with the sucking action in order to cut the label.

The transfer carousel 14 may comprise a plurality of suction protrusion arrangements 140 which are angularly distributed round the transfer carousel 14 and each comprising one of the plurality of recesses 140R. In particular, each suction protrusion of the suction protrusion arrangements 140 comprises a recess 140R, a leading expansion 140T and a trailing expansion 140C so that the recess 140R is interposed between the leading expansion 140T and the trailing expansion 140C. The leading expansion 140T and the trailing expansion 140C project radially from the transfer carousel 14, away from the first axis X1 of the transfer carousel 14. With respect to a rotation direction of the transfer carousel 14, the leading expansion 140T precedes the trailing expansion 140C.

The leading expansion 140T and the trailing expansion 140C are provided with suction ducts connected to a compressor or to a vacuum source to produce a sucking action by which the web 2 (and the separate labels 20) is kept adherent to the periphery of the transfer carousel 14 along part of the movement path, in order to keep the web 2 adherent to the suction protrusion arrangements 140 and to tension the web 2 while it is being cut. When the knife 130 is located in the recess 140R of the transfer carousel 14, the recess 140R, the leading expansion 140T and the trailing expansion 140C of the protrusions 140 are provided with suction ducts, these suction ducts being preferably independent of each other, so that the leading expansion 140T and the trailing expansion 140C perform the function of holding the web 2 while the ducts of the recess 140R perform the function of cutting the portion of web that operatively faces the knife 130. Therefore, the duration and intensity of the suction of the recess 140R is different from the suction of the leading expansion 140T and of the trailing expansion 140C (in particular, it is shorter in duration and more intense). At the same time, the knife 130 vibrates longitudinally to act in conjunction with the sucking action in order to cut the label.

In an example, the apparatus 1 comprises a cutting roller 13 and the knife 130 is located on the cutting roller 13 to rotate as one therewith. The cutting roller 13 rotates about a second axis X2, parallel to the first axis X1. In this case, the cutting roller 13 interacts with the transfer carousel 14 to cut the web 2 so as to divide it into labels. In particular, the knife 130 of the cutting roller 13 is inserted cyclically into a recess 140R so as to cut the web 2.

The cutting roller 13 includes a shaft 131, developing along the second axis X2 and configured to rotate around the second rotation axis X2. The cutting roller 13 includes a support structure 132, and a pair of bushings 133A and 133B configured to support the shaft 131 on the support structure 132.

The shaft 131 includes an internal rod 131A and an external sleeve 131B surrounding the internal rod 131A. The internal rod 131A is configured to support the knife 130 (i.e., the knife 130 is attached to the internal rod 131A). The external sleeve 131B includes an opening 134 inside which the knife 130 is inserted, so as to protrude away from the second axis X2. The cutting roller 13 includes a rotation actuator, configured to rotate the shaft 131 around the second axis X2. The rotation actuator can be connected to the internal rod 131A to rotate the internal rod 131A or connected to the external sleeve 131B to rotate the external sleeve 131B. In particular, the external sleeve 131B is fixed (directly or indirectly) to the internal rod 131A in such a way that the external sleeve 131B is dragged into rotation around the second axis X2 by the internal rod 131A. The external sleeve 131B and the internal rod 131A are fixed to each other by a key configured to constrain the rotary movement. The internal rod 131A is configured to cause the knife 130 fixed to the internal rod 131A to vibrate along the longitudinal axis (in particular, the longitudinal axis is parallel to the second rotation axis X2). In particular, the key binds the rotary movement of the internal rod 131A and the external sleeve 131B to each other, allowing the longitudinal vibration movement of the internal rod 131A. For this purpose, the opening 134 extends longitudinally so as to allow the vibration of the knife 130 inside the opening 134.

The shaft 131 includes one or more support elements, for example cup springs, to support the longitudinal vibration movement of the internal rod 131A. The cutting roller 13 includes a vibration actuator 135 configured to cause the internal rod 131A of the shaft 131 to vibrate.

The recess 140R is preferably provided with suction ducts. The leading expansion 140T and the trailing expansion 140C of the protrusions 140 are provided with suction ducts to generate a sucking action on the web 2 to keep the web 2 adherent to the transfer carousel 14 and to tension it while it is being cut.

In particular, the knife 130 separates a trailing end zone from a leading end zone of the next label, cutting the web in a separating zone located at the recess 140R.

In an example, the apparatus 1 comprises a gluing roller 12, rotating about a third axis X3, parallel to the first axis X1. The gluing roller 12 is configured to interact with the transfer carousel 14 so as to spread glue on surfaces of the web 2, in a gluing zone I. In particular, the gluing roller 12 applies glue on a leading end zone of a label and a trailing end zone of the next label (where the label and the next label are already cut or have not yet been cut). The gluing roller 12 may be present in the case where the knife 130 is located on the transfer carousel 14 or in the case where the knife 130 is located on the cutting roller 13.

In an example, the gluing roller 12 is positioned upstream of the cutting roller 13; alternatively, it may be positioned downstream of the cutting roller 13. Furthermore, the apparatus 1 might also comprise an additional transfer carousel 14′, distinct from the transfer carousel 14.

In an example embodiment, the transfer carousel 14 acts in conjunction with a labelling machine 18 to transfer the labels onto containers 21 in an unloading zone S, after the labels have been cut.

The additional transfer carousel 14′, if present, may be configured to receive the cut labels and to cooperate with a labelling machine 18 to transfer the labels onto containers 21 in an unloading zone S.

In an embodiment, the additional transfer carousel 14′ is configured to interact with the gluing roller 12 to apply glue.

The transfer carousel 14 may comprise a plurality of suction elements 141, angularly distributed around the periphery of the transfer carousel 14. These elements 141 are spaced from each other and from the suction protrusion arrangements 140. The suction elements 141 have the function of producing a sucking action by which the web 2 and the separate labels are kept adherent to the transfer carousel 14.

The knife 130 vibrates longitudinally, that is, perpendicularly to the web 2, that is, perpendicularly to a feed direction of the web 2 along the movement path. The knife 130 includes a serrated blade. The vibration frequency of the knife 130 may adopt a value of between 10 Hz and 40 kHz, and in the longitudinal translation of its vibrational motion, the knife may perform a stroke of between 0.02 and 0.5 mm.

In particular, the vibration frequency of the knife is between 10 Hz and 40 kHz, in the case where the actuator is an ultrasound actuator. The vibration frequency is between 10 Hz and 10 kHz, more preferably between 10 Hz and 1 kHz in the case where the actuator is a pneumatic actuator or an electromagnetic actuator.

The knife, in the longitudinal translation of its vibrational motion, is configured to perform a stroke of between 0.02 mm and 0.5 mm, preferably a stroke of between 0.02 and 0.1 mm and, more specifically, of approximately 0.04 mm in the case where the actuator is an ultrasound actuator. The stroke is between 0.1 and 0.5 mm, in the case where the actuator is a pneumatic actuator or an electromagnetic actuator.

1. A labelling apparatus, comprising:
a feed roller, configured to feed a web, the web being made from a label material;
a transfer carousel, configured to receive the web from the feed roller in a loading zone and including a plurality of recesses, angularly distributed along a periphery of the transfer carousel, the transfer carousel rotating about a first axis and the first axis being oriented longitudinally;
a knife, operating on the portion of web facing the recess, to separate pieces of web constituting labels and configured to vibrate longitudinally.

2. The apparatus according to claim 1, comprising an actuator, connected to the knife and configured to vibrate it.

3. The apparatus according to claim 1, wherein the vibration frequency of the knife is at least 1 kHz.

4. The apparatus according to claim 1, wherein the knife, in the longitudinal translation of its vibrational motion, is configured to perform a stroke of between 0.02 and 0.5 mm.

5. The apparatus according to claim 1, wherein the knife comprises a serrated blade.

6. The apparatus according to claim 1, comprising a cutting roller, rotating about a second axis parallel to the first axis and configured to act in conjunction with the recesses of the transfer carousel in a cutting zone, the knife being located on the cutting roller.

7. The apparatus according to claim 6, comprising a shaft, developing along the rotation axis and configured to rotate around the second rotation axis, the shaft comprising an internal rod and an external sleeve, surrounding the internal rod, the internal rod being configured to support the knife and the external sleeve being secured to the internal rod so as to rotate integrally with the internal rod around the second axis, the internal rod being free to vibrate longitudinally with respect to the external sleeve.

8. The apparatus according to claim 6, wherein the transfer carousel includes a plurality of suction protrusion arrangements, angularly distributed along a periphery of the transfer carousel and each comprising a corresponding recess of the plurality of recesses, the transfer carousel being configured to keep the web adherent to one or more of the suction protrusion arrangements.

9. The apparatus according to claim 8, comprising a gluing roller, configured to spread glue on the surfaces of the web, wherein the rotations of the gluing roller, of the cutting roller and of the transfer carousel are synchronized so that the gluing roller acts in conjunction with the suction protrusion arrangements of the transfer carousel to apply glue, and the knife of the cutting roller is inserted cyclically into the recesses of the suction protrusion arrangements to cut the web.

10. The apparatus according to claim 6, comprising a control unit programmed to set a vibration frequency of the knife on the basis of a rotation speed of the transfer carousel or of the cutting roller, or of the feed roller.

11. The apparatus according to claim 1, comprising a control unit programmed to synchronize the rotation of the transfer carousel and the vibration of the knife.

12. The Apparatus (1) according to claim 11, wherein the control unit is programmed to control the vibration of the knife (130) selectively with respect to the rotation of the transfer carousel (14), so as to activate the vibration in an angle of rotation of the transfer carousel (14) where the knife (130) comes into contact with the web (2) to cut it into labels.

13. The apparatus according to claim 6, comprising an additional transfer carousel, distinct from the transfer carousel, configured to interact with the gluing roller to apply glue and to cooperate with a labelling machine to transfer the labels onto containers in an unloading zone.

14. The apparatus according to claim 1, wherein the knife is located in the recesses of the transfer carousel.

15. A labelling method, comprising the following steps:
via a feed roller, feeding a web, the web being made from a label material;
providing a transfer carousel, including a plurality of recesses, angularly distributed along a periphery of the transfer carousel, the transfer carousel rotating about a first axis and the first axis being oriented longitudinally;
receiving the web from the feed roller in a loading zone of the transfer carousel;
longitudinally vibrating a knife;
with the knife, cutting a portion of web facing the recess, to separate pieces of web constituting labels.

16. The method according to claim 15, wherein at least one of the following conditions is true:
the vibration frequency of the knife is at least 1 kHz;
the stroke of the knife, in the longitudinal translation of its vibrational motion, is between 0.02 mm and 0.5 mm;
the knife (130) comprises a serrated blade.

17. The method according to claim 15, wherein the transfer carousel includes a plurality of suction protrusion arrangements, angularly distributed along a periphery of the transfer carousel and each comprising a corresponding recess of the plurality of recesses, the method comprising the following steps:
providing a cutting roller, rotating about a second axis parallel to the first axis, the knife being located on the cutting roller;
via the transfer carousel, keeping the web adherent to one or more of the suction protrusion arrangements, and
via the cutting roller, cooperating with the recesses of the transfer carousel in a cutting zone to cut the web.

18. The method according to claim 17, comprising a step, performed by a gluing roller, of applying glue on surfaces of the web, wherein the rotations of the gluing roller, of the cutting roller and of the transfer carousel are synchronized so that the gluing roller applies glue, on the surfaces of the web positioned at the suction protrusion arrangements of the transfer carousel, and the knife of the cutting roller is inserted cyclically into the recesses of the suction protrusion arrangements to cut the web.

19. The method according to claim 17, comprising the following steps:
via an actuator, starting the vibration of the knife;
via a control unit, setting a vibration frequency of the knife on the basis of a rotation speed of the transfer carousel or of the cutting roller, or of the feed roller;
via the control unit, synchronizing the rotation of the transfer carousel and the vibration of the knife so that the knife starts vibrating upstream of the recess and the knife stops vibrating downstream of the recess along a movement path of the transfer carousel.

20. The method according to claim 15, wherein the knife is located in the recesses of the transfer carousel.
